(19) United States
(12) Patent Application Publication
(10) Pub. No.: US 2012/0236538 A1
(43) Pub. Date: Sep. 20, 2012

(54) BACKLIGHT MODULE AND DISPLAY APPARATUS

(75) Inventors: Qian-shuang Hu, Guangdong (CN); Guofu Tang, Guangdong (CN)

(73) Assignee: SHENZHEN CHINA STAR OPTOELECTRONICS TECHNOLOGY CO., LTD., Shenzhen (CN)

(21) Appl. No.: 13/123,978

(22) PCT Filed: Mar. 25, 2011
(86) PCT No.: PCT/CN11/72184

§ 371 Date: Apr. 13, 2011

(30) Foreign Application Priority Data
Mar. 16, 2011 (CN) 201110065274.5

(51) Int. Cl. G09F 13/04

(52) U.S. Cl. 362/97.1

(57) ABSTRACT

The present invention provides a backlight module and a display apparatus. The display apparatus comprises the backlight module and a display panel. The backlight module comprises a back bezel, a light guide plate, at least one light source and a plurality of velcro tapes. The light source is disposed in the back bezel. The light guide plate is disposed in the back bezel and at one side of the light source. The velcro tapes are arranged on at least one side surface of the light guide plate and at least one corresponding inner surface of the back bezel. The invention can utilize the velcro tapes to simplify the assembling structure and process of the display apparatus.

### FIELD OF THE INVENTION

The present invention relates to a backlight module and a display apparatus, and more particularly to a side-light type backlight module and a display apparatus.

### BACKGROUND OF THE INVENTION

Liquid crystal displays (LCDs) have been widely applied in electrical products. Currently, most of LCDs are backlight type LCDs, and comprise a liquid crystal panel and a backlight module. According to the position of the light sources, the backlight module can be classified into a side-light type or a direct-light type, in order to provide LCDs with backlight sources.

Currently, the side-light type backlight module uses a light guide plate to guide the light of a light source, and the light source is disposed at one side of the light guide plate. In general, the light guide plate can be mounted on a back bezel by retaining walls or guide pillars of the back bezel. The liquid crystal panel of the LCD is supported on the backlight module by using a plastic frame, and a front frame is used to assemble the liquid crystal panel on the backlight module.

However, this assembly method needs more labor and time, and more elements are also needed for assembly, thereby increasing cost, labor and time for assembling the LCD. Furthermore, the back bezel is required to be processed, so as to form the retaining walls or guide pillars for holding the light guide plate, thus increasing the process cost and time, and occupying more inner space thereof.

As a result, it is necessary to provide a backlight module and a display apparatus to solve the problems existing in the conventional technologies, as described above.

### SUMMARY OF THE INVENTION

A primary object of the present invention is to provide a backlight module, wherein the backlight module comprises: a back bezel; at least one light source disposed in the back bezel; a light guide plate disposed in the back bezel for guiding the incident light from the light source; at least one optical film disposed above the light guide plate; and a plurality of velcro tapes arranged on at least one side surface of the light guide plate and at least one corresponding inner surface of the back bezel.

A secondary object of the present invention is to provide a display apparatus, wherein the display apparatus comprises a display panel and a backlight module. The backlight module comprises: a back bezel; at least one light source disposed in the back bezel; a light guide plate disposed in the back bezel for guiding the incident light from the light source; at least one optical film disposed above the light guide plate; and a plurality of velcro tapes arranged on at least one side surface of the light guide plate and at least one corresponding inner surface of the back bezel.

A further object of the present invention is to provide a display apparatus comprising a display panel and a backlight module. The backlight module comprises: a back bezel; at least one light source disposed in the back bezel; a light guide plate disposed in the back bezel for guiding the incident light from the light source; at least one optical film disposed above the light guide plate; and a plurality of velcro tapes arranged on at least one side surface of the light guide plate, at least one corresponding inner surface of the back bezel, the surrounding of a top surface of the light guide plate and the surrounding of a bottom surface of the display panel, wherein the total thickness of the velcro tapes on the bottom surface of the display panel and the top surface of the light guide plate is larger than the thickness of the optical film.

In one embodiment of the present invention, the bottom surfaces of the velcro tapes are white.

In one embodiment of the present invention, the velcro tapes are further arranged on the surrounding of a top surface of the light guide plate and the surrounding of a bottom surface of a display panel.

In one embodiment of the present invention, the total thickness of the velcro tapes on the bottom surface of the display panel and the top surface of the light guide plate is larger than the thickness of the optical film.

In one embodiment of the present invention, the velcro tape on the top surface of the light guide plate has a plurality of stoppers which extend from the inner edge of the velcro tape and bend upward.

In one embodiment of the present invention, the stoppers are formed on the velcro tape as one piece.

In one embodiment of the present invention, the stoppers are adhered to the light guide plate, individually.

In one embodiment of the present invention, the velcro tapes are made of an elastic or plastic material.

In comparison with the conventional back bezel of the backlight module which needs to be processed for holding a light guide plate or a panel. The backlight module and the display apparatus of the present invention can be assembled by using the velcro tapes, thus saving the process cost and time, and reducing the space occupied by the holding structures in the back bezel. Furthermore, the velcro tapes can buffer the light guide plate, the optical film and or display panel for positioning and protection.

The structure and the technical means adopted by the present invention to achieve the above and other objects can be best understood by referring to the following detailed description of the preferred embodiments and the accompanying drawings:

### DESCRIPTION OF THE DRAWINGS

FIG. 1 is a schematic diagram showing a backlight module and a display panel according to a first embodiment of the present invention;

FIG. 2 is a schematic diagram showing two velcro tapes in mounting according to a first embodiment of the present invention;

FIG. 3 is an exploded view showing a light guide plate, optical films and a display panel according to a second embodiment of the present invention; and

FIG. 4 is a cross-sectional view showing the light guide plate, the optical films and the display panel according to the second embodiment of the present invention.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

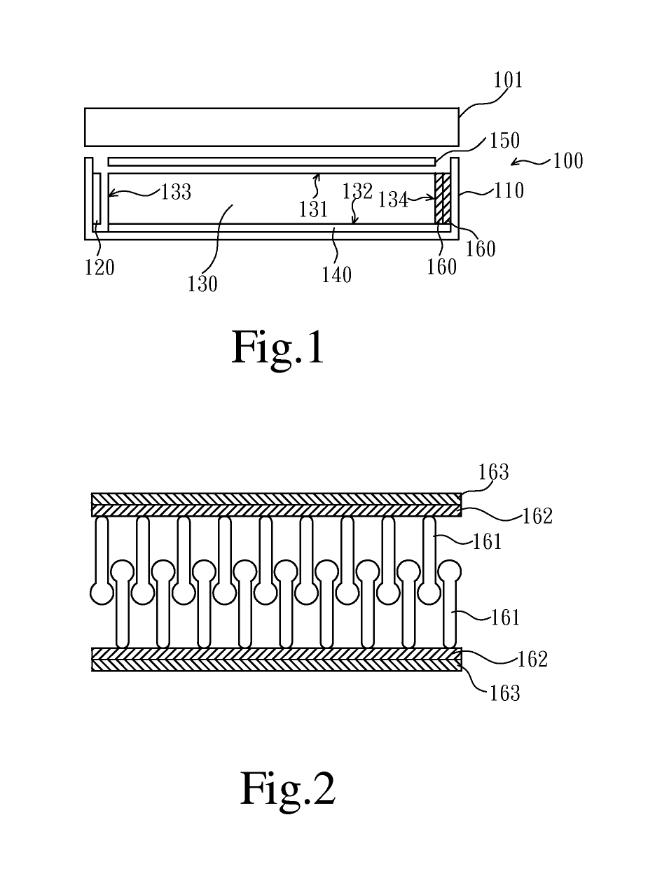

Referring to FIG. 1, a schematic diagram showing a backlight module and a display panel according to a first embodiment of the present invention is illustrated. The backlight module 100 of the present embodiment may be for example a side-light type backlight module and disposed opposite to a display panel 101 (such as a liquid crystal display panel), thereby forming a display apparatus (such as an LCD apparatus). The backlight module 100 comprises a back bezel 110, at least one light source 120, a light guide plate 130, a reflective layer 140, at least one optical film 150 and a plurality of velcro tapes 160. The back bezel 110 is configured to carry the light source 120, the light guide plate 130, the reflective layer 140 and the optical film 150. The at least one light source 120 is disposed at one side of the light guide plate 130 to emit light thereto, and the light is guided to be outputted by the light guide plate 130. The reflective layer 140 may be formed between the back bezel 110 and the light guide plate 130 for reflecting the light of the light source 120. The optical film 150 is disposed above the light guide plate 130 for optical improvement. The velcro tapes 160 are arranged between the back bezel 110 and at least one side of the light guide plate 130, so as to mount the light guide plate 130 in the back bezel 110.

Referring to FIG. 1 again, the back bezel 110 of the present embodiment may be made of an opaque material, such as plastic, metal or any combination material thereof. The light source 120 of the present embodiment are, for example, a cold cathode fluorescent lamp (CCFL), a light emitting diodes (LED), an organic light emitting diode (OLED), an electro-luminescence (EL) device, a light bar or any combination thereof.

In another embodiment, the light source 120 may be for example a light bar which includes a circuit broad and a lighting element (such as an LED chip). The circuit broad may be a printed circuit board (PCB) or a flexible printed circuit (FPC). The lighting element is disposed on the circuit broad. Furthermore, the light source 120 can be disposed at one side of the light guide plate 130. However, when the number of the at least one light source 120 is two, the light sources 120 can be disposed at two opposite sides of the light guide plate 130, respectively.

Referring to FIG. 1 again, the light guide plate 130 of the present embodiment may be made by the method of injection molding, and the material thereof may be photo-curable resin, polymethylmethacrylate (PMMA) or polycarbonate (PC) for guiding the light of light source 120 toward the liquid crystal display panel 101. The light guide plate 130 includes a light output surface 131, a light reflection surface 132, a light input side surface 133 and side surfaces 134. The light output surface 131 is formed on one side of the light guide plate 130 and faces to the liquid crystal display panel 101. The light output surface 131 may include a cloudy surface or a plurality of scattering patterns to uniform light outputted from the light guide plate 130, i.e. the situation of mura is prevented. In another embodiment, the light output surface 131 may include a plurality of protruding structures (not shown) to modify the direction of light, thereby condensing light and enhancing the brightness thereof, wherein the protruding structures may be prism-shaped structures or semicircle-shaped structures. The light reflection surface 132 is formed opposite to the light output surface 131 for reflecting light thereto. In the present embodiment, the light reflection surface 132 of the light guide plate 130 is parallel to the light output surface 131. The light reflection surface 132 may have a plurality of light guiding structures (not shown) formed thereon to guide light to the light output surface 131. The light guiding structures of the light reflection surface 132 may be a continuous V-shaped structure, i.e. V-cut structures, a cloudy surface or scattering patterns, thereby guiding the light of the light source 120 to be outputted from the light output surface 131. The light input side surface 133 is formed on one side or two opposite sides of the light guide plate 130 and corresponding to the light source 120 for allowing the light emitted by the light source 120 to be inputted in the light guide plate 130. The light input side surface 133 may have V-shaped structures (V-cut structures), S-shaped structures or a rough surface structure (not shown) to raise light incidence efficiency and light coupling efficiency. In this embodiment, the light input side surface 133 may be a plane surface vertical to the light reflection surface 132.

Referring to FIG. 1 again, in the present invention, the side surfaces 134 are used herein to denote the side surfaces around the light guide plate but not the light input side surface 133 (i.e. non-light input side surfaces) for arranging the velcro tapes 160. For example, in this embodiment, the light source 120 is disposed adjacent to one light input side surface 133 of the light guide plate 130, and the other three side surfaces thereof are used to denote the side surfaces 134. In another embodiment, two light sources 120 are disposed adjacent to two opposite light input side surfaces 133 of the light guide plate 130, and the other two side surfaces thereof are used to denote the side surfaces 134. Furthermore, in a further embodiment, the light sources 120 may be disposed in the interior of the light guide plate 130. That is, the light guide plate 130 has notches on the bottom thereof, and the light sources 120 are arranged in the notches, respectively.

Referring to FIG. 1 again, the reflective layer 140 (or a reflective sheet) of the present embodiment is preferably formed on the surface of the light guide plate 130, such as the light reflection surface 132, and merely exposes the light input side surface 133 for allowing light to be inputted and the light output surface 131 allowing light to be outputted. The reflective layer 140 may be made of a highly reflective material, such as Ag, Al, Au, Cr, Cu, In, Ir, Ni, Pt, Re, Rh, Sn, Ta, W, Mn, alloy of any combination thereof, white reflective paint with etiolation-resistant and heat-resistant properties or any combination thereof for reflecting light.

Referring to FIG. 1 again, the optical film 150 of the present embodiment may be a diffuser, a prism sheet, a turning prism sheet, a brightness enhancement film (BEF), a dual brightness enhancement film (DBEF), a diffused reflective polarizer film (DRPF) or any combination thereof disposed above the light guide plate 130 and positioned on the light output surface 131 by the positioning convex portions 133 for improving the light outputted from the light guide plate 130.

Referring to FIG. 1 again, the optical film 150 of the present embodiment may be a diffuser, a prism sheet, a turning prism sheet, a brightness enhancement film (BEF), a dual brightness enhancement film (DBEF), a diffused reflective polarizer film (DRPF) or any combination thereof disposed above the light guide plate 130 and positioned on the light output surface 131 for improving the light outputted from the light guide plate 130.

Referring to FIG. 1 and FIG. 2, FIG. 2 is a schematic diagram showing two velcro tapes in mounting according to a first embodiment of the present invention is illustrated. The velcro tapes 160 of the present embodiment are disposed on at least one side surface 134 of the light guide plate 130 and at least one corresponding inner surface of the back bezel 110. That is, the velcro tapes 160 are disposed between the light guide plate 130 and the back bezel 110 for mounting the light guide plate 130 on the back bezel 110. The velcro tapes 160 are preferably made of an elastic or plastic material, such as PVC, PC or ABS. The bottom surfaces of the velcro tapes 160 are preferably white for reflecting light, and thus the arrangement of the reflective layer 140 can be reduced. The velcro tape 160 can include mushroom convex portions 161, a substrate 162 and a back adhesive 163. The mushroom convex portions 161 are disposed on one side of the substrate 162 of the velcro tape 160. The convex portions 161 of two corresponding velcro tapes 160 can be engaged with each other for fastening. The back adhesive 163 is formed on another side of the substrate 162 for being adhered to a plane surface, such as the side surfaces of the light guide plate 130 and the back bezel 110. Therefore, the velcro tapes 160 can be adhered to the side surfaces of the light guide plate 130 and the back bezel 110, respectively, and the convex portions 161 of the corresponding velcro tapes 160 of the back bezel 110 and the light guide plate 130 can be engaged with each other for allowing the light guide plate 130 to fastened in the back bezel 110 and preventing the light guide plate 130 from vibration therein.

With the fixing of the velcro tapes 160, the light guide plate 130 can be simply and directly mounted in the back bezel 110. Therefore, it is not required to process the back bezel 110 and the light guide plate 130 for forming the holding structures, such as retaining walls or guide pillars. Thus, the process cost and time can be saved, and the space occupied by the holding structures in the back bezel 110 can be reduced. Moreover, the velcro tapes 160 arranged between the back bezel 110 and the light guide plate 130 can have a buffer effect to buffer the move of the light guide plate 130 for reducing the damages of the light guide plate 130.

When assembling the backlight module 100 and the display panel 101 of the present embodiment, firstly, the velcro tape 160 is adhered to at least on inner side surface of the back bezel 110, and then the reflective layer 140 (such as a reflective sheet) is disposed on the back bezel 110. Subsequently, the light source 120 is disposed on the back bezel 110. Subsequently, the corresponding velcro tape 160 is adhered to at least one corresponding side surface 134 of the light guide plate 130, and the light guide plate 130 is mounted in the back bezel 110, wherein the convex portions 161 of the velcro tapes 160 of the back bezel 110 and the light guide plate 130 can be engaged with each other. Subsequently, the optical film 150 is disposed above the light guide plate 130, thereby achieving the backlight module 100. Subsequently, the display panel 101 is disposed on the backlight module 100 to form the display apparatus.

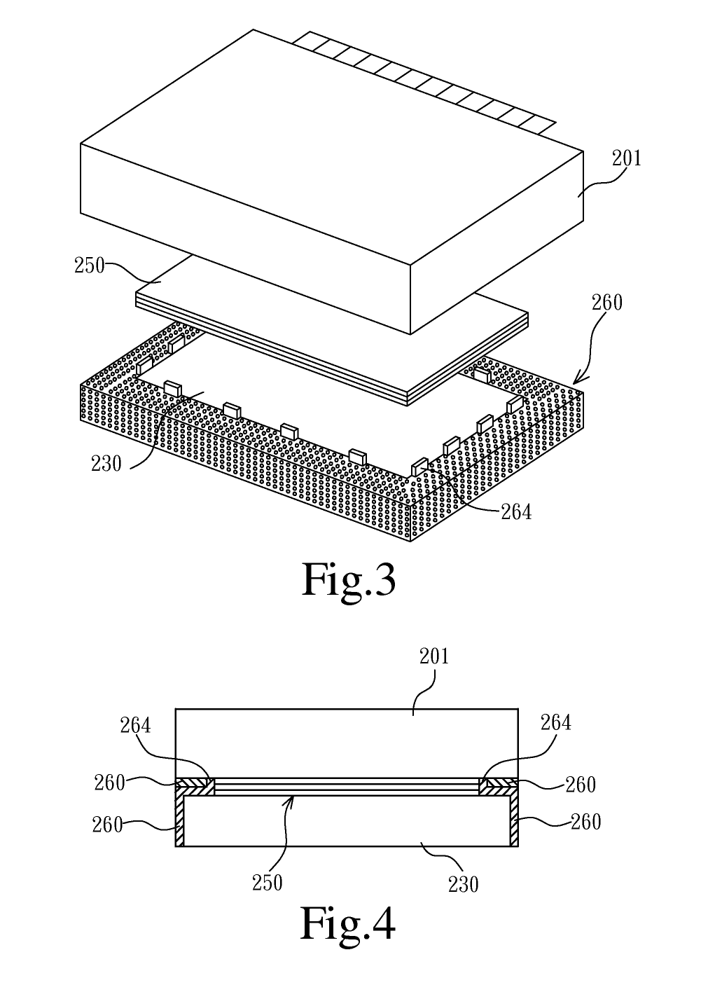

Referring to FIG. 3 and FIG. 4, FIG. 3 is an exploded view showing a light guide plate, optical films and a display panel according to a second embodiment of the present invention, and FIG. 4 is a cross-sectional view showing the light guide plate, the optical films and the display panel according to the second embodiment of the present invention. Only the difference between the embodiment and the first embodiment will be described hereinafter, and thus the similar portions there-between will be not stated in detail herein. In comparison with the first embodiment, the velcro tapes 260 of the second embodiment are further arranged on the surrounding of a top surface (the light output surface) of the light guide plate 230 and the surrounding of a bottom surface of the display panel 201. At this time, the velcro tape 260 on the bottom surface of the display panel 201 can be correspondingly fastened and engaged with the velcro tape 260 on the top surface of the light guide plate 230, thereby allowing the display panel 201 to be mounted on the light guide plate 230 of the backlight module. The velcro tapes 260 have the buffer effect, thus buffering and protecting the glass substrate of the display panel 201, and reducing the use of plastic frames and buffers.

In the second embodiment, the velcro tape 260 can arranged around the optical films 250, i.e. the optical films 250 can be disposed in the frame formed by the velcro tape 260. Since the velcro tapes 260 have the buffer effect to buffer the move of the optical films 250 due to the thermal expansion and contraction thereof, the warp and deformation of the optical films 250 can be alleviated. At this time, the total thickness of the velcro tapes 260 on the bottom surface of the display panel 201 and the top surface of the light guide plate 230 is preferably larger than the thickness of the optical films 250. Furthermore, the velcro tape 260 on the top surface of the light guide plate 230 can have a plurality of stoppers 264, such as square stoppers or stoppers of other shapes, which extend from the inner edge of the velcro tape 260 and bend upward. The stoppers 264 are disposed around the optical films 250, so as to engage the optical films 250 in the frame formed by the velcro tape 260. The stoppers 264 are preferably formed on the velcro tape 260 as one piece, i.e. the stoppers 264 and the velcro tape 260 have the same material. In another embodiment, the stoppers 264 may be adhered to the light guide plate 230 or the velcro tape 260, individually. That is, the stoppers 264 may be not formed on the velcro tape 260 as one piece.

As described above, the backlight module and the display apparatus of the present invention can be assembled by using the velcro tapes. It is not required to process the back bezel and the light guide plate for forming the holding structures, such as retaining walls or guide pillars, thus saving the process cost and time, and reducing the space occupied by the holding structures in the back bezel. Moreover, the velcro tapes can have a buffer effect for buffering the light guide plate, the optical film and the display panel.

The present invention has been described with a preferred embodiment thereof and it is understood that many changes and modifications to the described embodiment can be carried out without departing from the scope and the spirit of the invention that is intended to be limited only by the appended claims.

1. A display apparatus, comprising:
a display panel; and
a backlight module comprising:
a back bezel;
at least one light source disposed in the back bezel;
a light guide plate disposed in the back bezel for guiding the incident light from the light source;
at least one optical film disposed above the light guide plate; and
a plurality of velcro tapes arranged on at least one side surface of the light guide plate, at least one corresponding inner surface of the back bezel, the surrounding of a top surface of the light guide plate and the surrounding of a bottom surface of the display panel, wherein the total thickness of the velcro tapes on the bottom surface of the display panel and the top surface of the light guide plate is larger than the thickness of the optical film.

2. A backlight module comprising:
a back bezel;
at least one light source disposed in the back bezel;
a light guide plate disposed in the back bezel for guiding the incident light from the light source;
at least one optical film disposed above the light guide plate; and
a plurality of velcro tapes arranged on at least one side surface of the light guide plate and at least one corresponding inner surface of the back bezel.

3. The backlight module according to claim 2, wherein the bottom surfaces of the velcro tapes are white.

4. The backlight module according to claim 2, wherein the velcro tapes are further arranged on the surrounding of a top surface of the light guide plate and the surrounding of a bottom surface of a display panel.

5. The backlight module according to claim 4, wherein the total thickness of the velcro tapes on the bottom surface of the display panel and the top surface of the light guide plate is larger than the thickness of the optical film.

6. The backlight module according to claim 4, wherein the velcro tape on the top surface of the light guide plate has a plurality of stoppers which extend from the inner edge of the velcro tape and bend upward.

7. The backlight module according to claim 6, wherein the stoppers are formed on the velcro tape as one piece.

8. The backlight module according to claim 6, wherein the stoppers are adhered to the light guide plate, individually.

9. The backlight module according to claim 2, wherein the velcro tapes are made of an elastic or plastic material.

10. A display apparatus, comprising:
a display panel; and
a backlight module comprising:
a back bezel;
at least one light source disposed in the back bezel;
a light guide plate disposed in the back bezel for guiding the incident light from the light source;
at least one optical film disposed above the light guide plate; and
a plurality of velcro tapes arranged on at least one side surface of the light guide plate and at least one corresponding inner surface of the back bezel.

11. The display apparatus according to claim 10, wherein the bottom surfaces of the velcro tapes are white.

12. The display apparatus according to claim 10, wherein the velcro tape arranged on the top surface of the light guide plate has a plurality of stoppers which extend from the inner edge of the velcro tape and bend upward.

13. The display apparatus according to claim 12, wherein the stoppers are formed on the velcro tape as one piece.

14. The display apparatus according to claim 12, wherein the stoppers are adhered to the light guide plate, individually.

15. The display apparatus according to claim 10, wherein the velcro tapes are made of an elastic or plastic material.
